(19) United States
(12) Patent Application Publication
(10) Pub. No.: US 2006/0082557 A1
(43) Pub. Date: Apr. 20, 2006

(54) Combined detection of position-coding pattern and bar codes

(75) Inventors: Petter Ericson, Malmo (SE); Stefan Lynggaard, Lund (SE)

Correspondence Address: BIRCH STEWART KOLASCH & BIRCH, PO BOX 747, FALLS CHURCH, VA, 22040-0747, US

(73) Assignee: Anoto IP Lic HB, Lund (SE)

(21) Appl. No.: 11/084,090

(22) Filed: Mar. 21, 2005

Related U.S. Application Data
(63) Continuation-in-part of application No. 09/812,906, filed on Mar. 21, 2001.
(60) Provisional application No. 60/208,167, filed on May 31, 2000.

(30) Foreign Application Priority Data
Apr. 5, 2000 (SE) 0001236-9

(51) Int. Cl. G09G 5/00

(52) U.S. Cl. 345/179

(57) ABSTRACT

A form has a form layout with at least one entry field. It may be printed on a base in the form of a sheet (or any other surface). The surface of the base may have a position-coding pattern. The entry field can be completed using a user unit that has an optical detector to detect positions on the sheet utilizing the position-coding pattern. The optical detector can thereby enable digital recording of the information entered in the entry field and input thereof to an information management system. The surface may also have a bar code that can identify the form layout to the information management system, suitably after being recorded by means of the optical detector in the user unit. The user unit with such bar code reading capability may also be generally applicable to support registration of a product with is labeled with a bar code and to link the bar code, and thereby the product or information related thereto, to information entered on a position-coded form.

### CROSS-REFERENCE TO RELATED APPLICATIONS

This is a continuation-in-part of U.S. patent application Ser. No. 09/812,906, which was filed on Mar.23, 2001, claiming priority benefits based on Swedish Patent Application No. 0001236-9, filed Apr. 5, 2000, and U.S. Provisional Application 60/208167, filed May 31, 2000, the technical disclosures of both of which are hereby incorporated herein by reference.

### FIELD OF THE INVENTION

The invention relates generally to information processing and, more specifically, relates to data entry using optical sensor technology.

### BACKGROUND OF THE INVENTION

Forms and the like are used to a considerable extent in today's society. The aim of such forms is to ensure that a user fills in the correct information and that this is carried out in a structured way. Therefore, forms usually consist of a sheet of paper containing printed form layouts with instructions concerning what information is to be filled in and where.

With modern computer technology, it is possible to record automatically the information that is entered on a form. One way of doing this is with a flat-bed scanner connected to a computer system. This creates an information file in a graphical format (e.g., tiff format). Such simple recording makes it possible to create a copy of the form at a later stage. The copy can then be printed and interpreted manually.

It is also possible to process the created file by OCR technology that can recognize text both in the layout of the form and in the fields which have been filled in by a user. But doing so may require comprehensive and complicated image analysis software. Determining the identity and orientation of the form and identifying and deciphering the entries on the form may also be difficult.

Currently, if an individual does not have access to advanced flat-bed scanners and associated software that may be required for the subsequent image analysis of a scanned form, automatic form recordation may be difficult.

### SUMMARY OF A FEW ASPECTS OF THE INVENTION

Generally described, the invention includes a form. The form may have a surface. The surface may have a position-coding pattern optically detectable by a pen device. It may also have a form layout indicating at least one position-coded entry field for receipt of information. The surface may also have a bar code optically detectable by the pen device and being indicative of at least one of the form layout and a unique identity of the form.

The invention may also include a method for generating a form. The printer may print, on a surface having a position-coding pattern detectable by an optical detector, a form layout indicating at least one position-coded entry field for receipt of information. Moreover, the printer may print on the surface a bar code indicative of the form layout. A computer program directing the printer to generate the form in this manner may be written in a computer-readable medium.

The invention may also include another method for generating a form. The printer may print on a surface a position-coding pattern detectable by an optical detector, and a form layout indicating at least one entry field for receipt of information. Moreover, the printer may print on the surface a bar code indicative of each individual printing of a form layout.

A computer program may process the form. To do so, it may receive from an optical position detector, position data corresponding to movement of a device containing the optical sensor over a surface having a position-coding pattern detectable by the optical position detector. It may also receive, from a bar code detector in the device, bar code data representing a bar code on the surface. The program may then determine from the bar code data a form layout printed on the surface and determine from the position data an information entry in an entry field defined by the form layout. Alternatively, the program may determine from the position data a form layout printed on the surface and determine from the bar code data an instance identifier which is indicative of an individual identity of the surface.

A pen device may be configured to capture images of a surface using an optical detector in the pen device. The pen device may also be configured to selectively activate a position detection process or a bar code detection process to operate on at least a subset of the images, the position detection process resulting in position data and the bar code detection process resulting in bar code data. The pen device with such combined bar code and position detection capability may be generally applicable to support registration of a product with is labeled with a bar code and to link the bar code, and thereby the product or information related thereto, to information entered on a position-coded form.

The foregoing summarizes only a few aspects of the invention and is not intended to be reflective of the full scope of the invention as claimed. Additional features and advantages of the invention are set forth in the following description, apparent from the description, or may be learned by practicing the invention. Moreover, both the foregoing general description and the following detailed description are exemplary and explanatory and are intended to provide further explanation of the invention as claimed.

### BRIEF DESCRIPTION OF THE DRAWINGS

FIG. 1A shows an overview of a system in accordance with an exemplary embodiment of the present invention; FIG. 1B shows a position-coding pattern which may be used in an exemplary embodiment of the present invention; and FIG. 1C shows a user unit, partly in section, in accordance with an exemplary embodiment of the present invention.

FIG. 2 shows a form in accordance with an exemplary embodiment.

FIG. 3 shows an identifying pattern in accordance with an exemplary embodiment of the present invention.

FIG. 4 shows the application of a number of rules with position information as input data in accordance with an exemplary embodiment of the present invention.

FIG. 5 shows a flow chart describing a method for generating forms in accordance with an exemplary embodiment of the present invention.

FIG. 6 shows a flow chart describing a method for recording form data for an information entry in accordance with an exemplary embodiment of the present invention.

FIG. 7 shows an information management system in accordance with an exemplary embodiment of the present invention.

FIG. 8 shows a flow chart describing a method for identifying and decoding a bar code in accordance with an exemplary embodiment of the present invention.

FIG. 9 illustrates an exemplary sub-step of the method in FIG. 8, wherein part of an image (left) is summed in one direction for creation of a one-dimensional luminance profile (right).

FIG. 10 illustrates an exemplary sub-step of the method in FIG. 8, wherein a one-dimensional luminance profile is differentiated and filtered.

FIG. 11 illustrates an exemplary step of the method in FIG. 8, wherein the mutual displacement between one-dimensional luminance profiles (left) is determined based upon the result of a correlation procedure (right).

FIG. 12 illustrates an exemplary sub-step of the method in FIG. 8, wherein the a fractional displacement is determined based upon the result of a correlation procedure.

FIG. 13 illustrates the use of buffers for merging one-dimensional image profiles to a single bar code profile, in accordance with an exemplary embodiment.

FIG. 14 illustrates different stages during processing to eliminate fictitious edges in accordance with an exemplary embodiment.

### DETAILED DESCRIPTION OF EMBODIMENTS

Generally, the invention includes a form having a form layout with at least one entry field. It may be printed on a base in the form of a sheet (or any other surface). The surface of the base may have a position-coding pattern. The entry field can be completed using a user unit that has an optical sensor to detect positions on the sheet utilizing the position-coding pattern. The optical sensor can thereby enable digital recording of the information entered in the entry field. The surface may also have an identity pattern that can identify the form layout after detection by the sensor.

Thus, the user unit may be operated to record not only position data representative of its movement over the position-coding pattern on the form, but also data representative of the identity pattern on the form. This latter identity data can be used, in a computer system associated with the user unit, to link the recorded position data to a particular database form in the computer system. Specifically, the information entered in a particular entry field can be linked to, and stored in, a particular record in the database form. The structuring of the completed information may thus be carried out automatically.

The information which is stored in the information entry may comprise output data which is generated when the computer system applies a processing rule to the recorded position data. The processing rule may be specific to the particular entry field in which the position data was recorded. The format of the output data of the processing rule may be from the group comprising: Boolean variable, integer, real number, text string or a graphical format. These formats can then be processed in various general ways by the computer system.

The computer system may be contained in the user unit. This enables both mobile recording and interpretation of information which is entered on a form. Processed data can thereafter be forwarded to other systems. Alternatively, the computer system may be contained in an external apparatus that receives recorded data from the user unit, for example a server, a personal computer, PDA (Personal Digital Assistant), a mobile phone, etc.

The above recording of data entered on a form does not require-a flat-bed scanner equipped with advanced software for image analysis. The completion.:of the form and recording of the information entered may be carried out in a single stage. The form may not need to be sent away, but can, for example, be retained as a copy of what was entered on it. Mobile recording can be carried out in the field. The computer system may be configured to process the entered information in a simple and structured way, reducing the danger of errors.

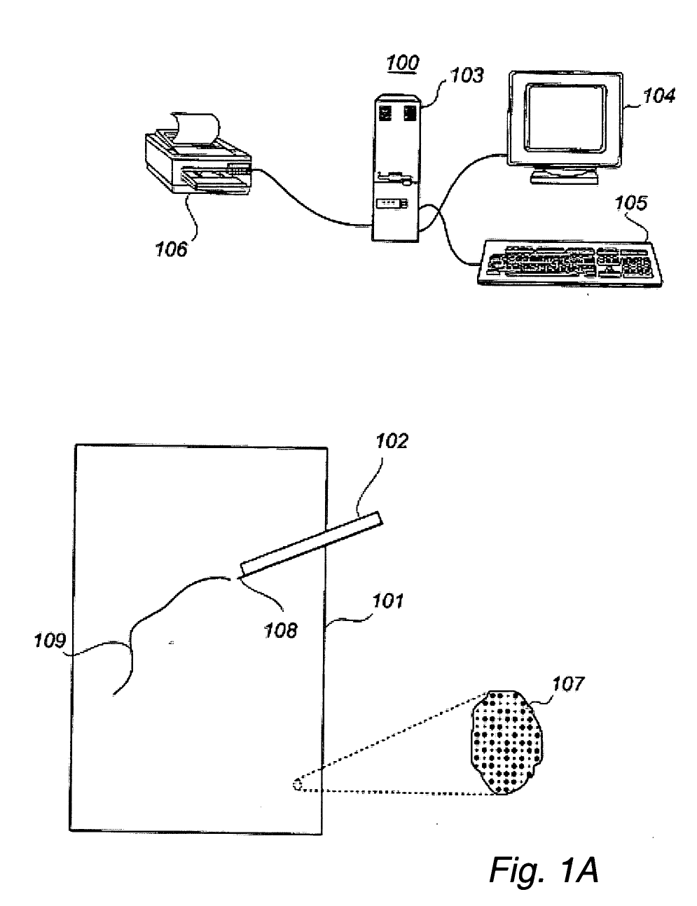

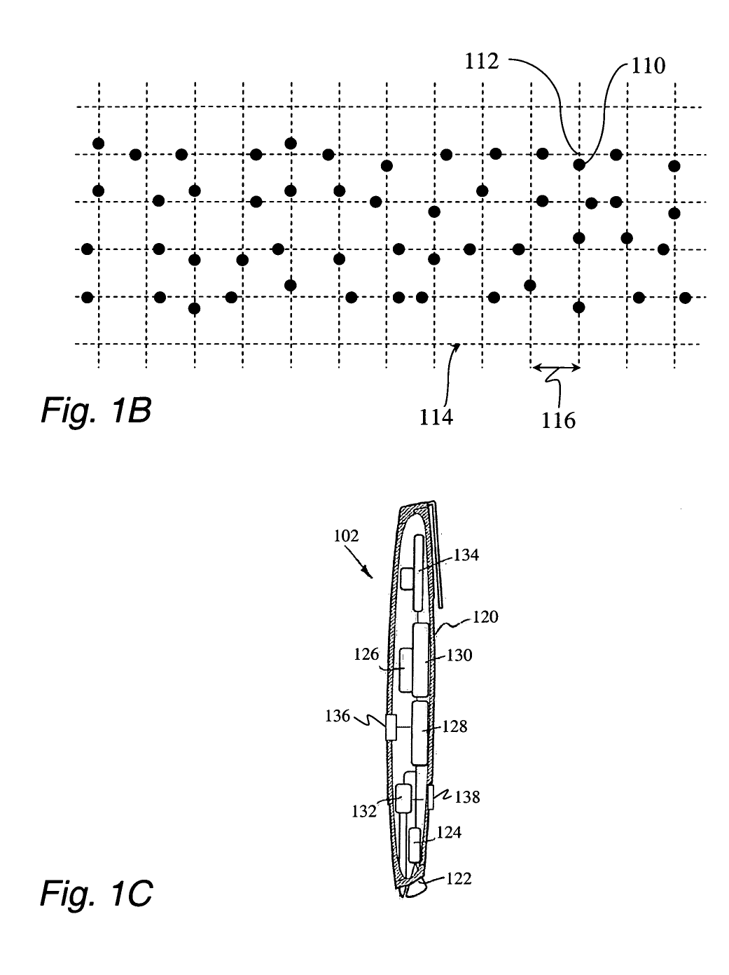

FIG. 1A shows a computer system 100 capable of generating and processing forms in accordance with typical embodiments of the present invention. FIG. 1A also depicts a base 101 in the form of a sheet and a user unit 102 having an optical sensor.

The computer system 100 may include personal computer 103 to which is connected a display 104 and a keyboard 105. However, forms may be generated and processed by both larger and smaller computer systems than those shown in FIG. 1A. The computer system 100 may include a printer 106, which may be a laser printer, an ink-jet printer, or any other type of printer.

The base 101 can be a sheet of paper, but other materials such as a plastic, laminate, or other paper stock such as cardboard may provide a suitable surface on which to create a form. In such a form, the base 101 is provided with a position-coding pattern 107 (shown enlarged). The printer 106 may create the position-coding pattern 107, or the base 101 may be manufactured with the position-coding pattern.

The position-coding pattern 107 may be arranged so that if a part of the pattern of a certain minimum size is recorded optically, then this part of the pattern's position in the pattern and hence on the base can be determined unambiguously. The position-coding pattern can be of any one of various known configurations. For example, position-coding patterns are known from the Applicant's patent publications U.S. Pat. No. 6,570,104, U.S. Pat. No. 6,663,008, U.S. Pat. No. 6,667,695, U.S. Pat. No. 6,674,427, and WO 01/16691, the technical disclosures of which are hereby incorporated by reference.

In the position-coding patterns described in those applications, each position may be coded by a plurality of symbols and one symbol may be used to code a plurality of positions. The position-coding pattern 107 shown in FIG. 1A is constructed in accordance with U.S. Pat. No. 6,570,104. A larger dot may represent a “one” and a smaller dot may represent a “zero”.

The position coding pattern may be of any other suitable design, for example as illustrated in FIG. 1B and further described in aforesaid U.S. Pat. No. 6,663,008. Principally, the coding pattern of FIG. 1B is made up of simple graphical symbols, which can assume four different values and thus are capable of coding two bits of information. Each symbol consists of a mark 110 and a spatial reference point or nominal position 112, the center of the mark 110 being displaced or offset a distance in one of four different directions from the nominal position 112. The value of each symbol is given by the direction of displacement. The symbols are arranged with the nominal positions forming a regular raster or grid 114 with a given grid spacing 116. The grid may be virtual, i.e. invisible to any decoding device, and thus not explicitly included in the coding pattern. Each absolute position is coded in two dimensions by the collective values of a group of symbols within a coding window, e.g. containing 6×6 adjacent symbols. Further, the coding is “floating”, in the sense that an adjacent position is coded by a coding window displaced by one grid spacing. In other words, each symbol contributes in the coding of several positions.

Other types of position-coding patterns are known, for example, from patent publications U.S. Pat. No. 6,330,976, U.S. 2004/0085287, and U.S. Pat. No. 5,852,434.

Returning now to FIG. 1A, a user unit 102 is illustrated, by way of example only, as being designed as a pen. The user unit 102 may have a pen point 108 that can be used to write text and numbers or draw figures on the base. The user unit 102 may also comprise an optical sensor that utilizes the position-coding pattern 107 on the base 101 to detect positions on the position-coding pattern. When a figure 109 is drawn on the base 101, the optical sensor may detect a sequence of positions on the base 101 that correspond to the movement of the user unit 102 over the base 101. This sequence of positions forms a digital record of the figure 109 drawn on the base 101. In the same way, hand-written numbers and letters can also be recorded digitally.

As indicated by the trace 109, the pen point 108 may deposit ink in the base 101. This writing ink is suitably of such a type that it is transparent to the optical sensor, to avoid the writing ink interfering with the detection of the pattern. Similarly, the form layout may be printed on the base in a printing ink which is invisible to the sensor, although this may not be necessary. On the other hand, the position-coding pattern is printed on the base in a printing ink which is visible to the sensor. In one embodiment, the optical sensor is designed to sense the position-coding pattern by detecting radiation in the infrared wavelength region. The identifying pattern may or may not, depending on implementation, be printed on the base in a printing ink which is visible to the sensor.

An exemplary embodiment of the user unit is further illustrated in FIG. 1C. Here, the user unit comprises a pen-shaped casing or shell 120 that defines a window or opening 122, through which images are recorded. The casing contains a camera system, an electronics system and a power supply. The camera system 124 may comprise at least one illuminating light source, a lens arrangement and an optical sensor. The light source, suitably a light-emitting diode (LED) or laser diode, may illuminate a part of the area that can be viewed through the window 122, e.g. by means of infrared radiation. An image of the viewed area may be projected on the image sensor by means of the lens arrangement. The optical sensor may be a two-dimensional CCD or CMOS detector which is triggered to capture images at a fixed frame rate, for example of about 70-100 Hz.

The power supply for the pen may be a battery 126, which alternatively can be replaced by or supplemented by mains power (not shown).

The electronics system may comprise a control device 128 which is connected to a memory block 130. The control device 128 may be responsible for the different functions in the user unit and may be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory block 130 may comprise different types of memory, such as a working memory (e.g. a RAM) and a program code and persistent storage memory (a non-volatile memory, e.g. flash memory). Associated user unit software may be stored in the memory block 130 for execution by the control device 128 in order to provide a control system for the operation of the user unit.

A contact sensor 132 may be operatively connected to the pen point to detect when the user unit is applied to (pen down) and/or lifted from (pen up) a base, and optionally to allow for determination of the application force. Based on the output of the contact sensor 132, the camera system 124 is controlled to capture images between a pen down and a pen up. The control unit processes the images to calculate positions encoded by the imaged parts of the position-coding pattern. Such processing can, e.g. be implemented according to Applicant's prior publications: U.S. 2003/0053699, U.S. 2003/0189664, U.S. 2003/0118233, U.S. 2002/0044138, U.S. Pat. No. 6,667,695, U.S. Pat. No. 6,732,927, U.S. 2003/0122855, U.S. 2003/0128194, and references therein. The resulting sequence of temporally coherent positions forms an electronic representation of a pen stroke.

The electronics system may further comprise a communications interface 134 for transmitting or exposing information recorded by the user unit to a nearby or remote apparatus, such as a personal computer, a cellular mobile telephone, PDA, network server etc, for further processing, storage, or transmission. The communications interface 134 may thus provide components for wired or wireless short-range communication (e.g. USB, RS232, radio transmission, infrared transmission, ultrasound transmission, inductive coupling, etc), and/or components for wired or wireless remote communication, typically via a computer, telephone or satellite communications network. The position information that is transmitted can be representative of the sequence of positions recorded by the user unit in the form of a set of pairs of coordinates, a polygon train, or in any other form. The position information may also be stored locally in the user unit and transmitted later, when a connection is established.

The pen may also include an MMI (Man Machine Interface) 136 which is selectively activated for user feedback. The MMI may include a display, an indicator lamp, a vibrator, a speaker, etc. Still further, the pen may include one or more buttons and/or a microphone 138 by means of which it can be activated and/or controlled.

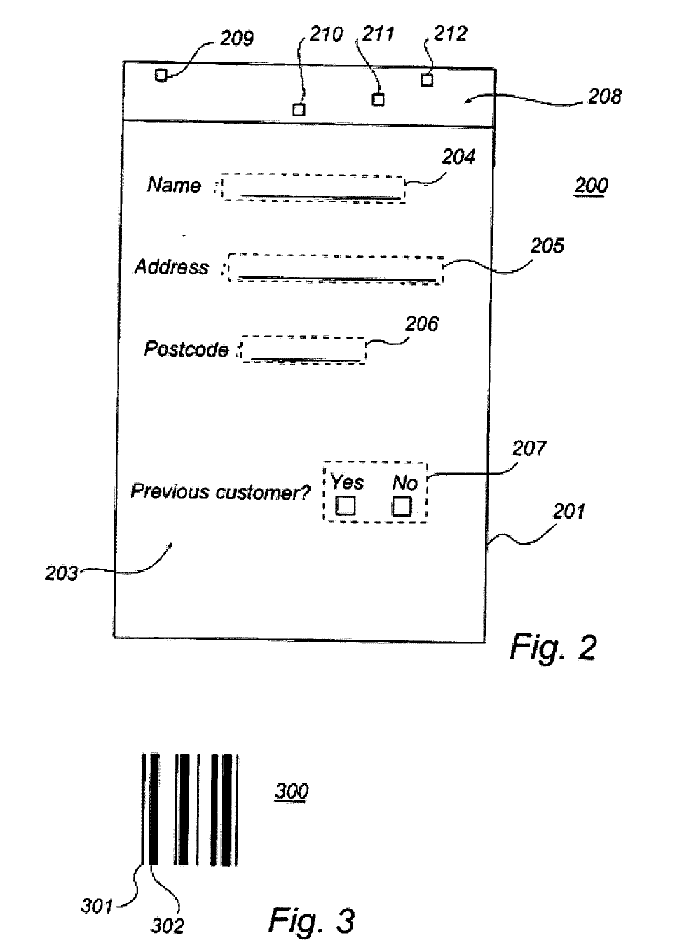

FIG. 2 shows a form 200 in accordance with an exemplary embodiment of the present invention. The form 200 consists of a base 201 (or any other surface) provided with a position-coding pattern (not shown in FIG. 2). A form layout 203 is also printed on the base 201. The form layout 203 comprises a plurality of entry fields 204-207. While the surface disclosed in the figures comprises a single discrete surface such as a sheet of paper, the term surface as used herein may refer to multiple surfaces or multiple pages of a multi-page form.

The form 200 may enable collection of information. For example, the user may write text or a number in any of the entry fields 204-207. Information provided by a user may be text (e.g., a name or an address). It may also be a whole number, such as the age of a person in whole years, or a real number, such as a patient's body temperature in degrees Celsius to two decimal places. It can also be the reply to a multi-choice question. A form may enable the entry of other types of information, too.

The user may download the form layout from an Internet server. The form layout may also be stored in other computer systems, such as the user unit 102.

While an entry field 204-207 is completed by a user using a user unit 102, the user unit may record a sequence of positions corresponding to a digital record of the entered information. The recorded information can then be processed or stored locally in the user unit. Alternatively, it can be transmitted to another computer system for processing or storage. Such processing may require knowledge of the form layout.

The form 200 may also comprise an identifying pattern or identity pattern 208, which may be marked when the entry fields 204-207 of the form layout 203 are completed. The identity pattern may be marked, for example, by drawing a cross through a box defined by the pattern or circling a location defined by the pattern. The user may instead be invited to fill in a missing feature in a figure.

In FIG. 2, the identifying pattern consists of four boxes 209-212. When these are marked with a cross using the user unit, a set of positions may be recorded by the optical sensor. By finding a matching set of positions in a database of position patterns representing possible form layouts, a computer processing the position data can determine the form layout 203 corresponding to the positions marked. The entry fields 204-207 and the four boxes 209-212 may be completed in any order. In one embodiment, the absolute positions in the position-coding pattern that are recorded when the boxes are marked are utilized to identify the form layout. In another embodiment, the relative positions of the different boxes in the position-coding pattern are used to identify the form layout.

The identifying pattern 208 may also be utilized to determine the scale in which the form layout has been printed in relation to the position-coding pattern. The boxes 209-212 may be placed near the different corners of the sheet in order to facilitate this and provide higher resolution. The information can then be used to normalize the position information which arises, so that the correct position information is associated with the correct information entry.

As an alternative to this method of normalizing, a printer creating the form can be provided with a position-coding pattern reading device. This allows the printer to print the form layout at a known location relative to the position-coding pattern. Also, a printer could print the form and, during the printing process, sense the position coordinates defining the form layout and feed the position coordinates back to the computer system.

A method of generating a form may generally involve printing a form layout, comprising at least one entry field, on a surface; in connection with the printing, detecting the positions in a position-coding pattern on which the form layout is superimposed; and transferring data on the positional relationship between the form layout and the position-coding pattern to the computer system that will process form input.

The identifying pattern may be over-specified by providing more position information than what is required to identify a form layout unambiguously. This may enable recording of scale information.

A user who wants to generate a number of forms may acquire a pack of sheets which are already provided with a position-coding pattern and load a number of such sheets into his/her printer. All the sheets in such a pack can be identical, i.e. the position-coding pattern on all sheets may code the same set of positions. It is also possible for each sheet in a pack to be unique, so that the sets of positions coded by the position-coding pattern on the different sheets are mutually exclusive. The user can also in principle print the position-coding pattern himself using a printer having sufficiently high printing resolution.

The position-coding patterns described in Applicant's patent publications U.S. Pat. No. 6,570,104, U.S. Pat. No. 6,663,008, U.S. Pat. No. 6,667,695, U.S. Pat. No. 6,674,427, and WO 01/16691 are capable of defining a very large total area of positions (multiple A4-sized pages) with good resolution. The total area can be subdivided into mutually unique subareas suitable for use on form sheets. Each subarea is thus implemented on a tangible sheet as a corresponding subset of the overall position-coding pattern. The positions that are encoded on a pack of sheets that a user can acquire may be known to the system responsible for processing information entered on the form. When all the sheets in a pack are identical, the system knows where on a sheet a position in the position-coding pattern is located. If sheets are unique within the pack, the system also knows on which sheet a position in the position-coding pattern is located. This makes possible parallel recording of a plurality of forms.

Parallel recording can also be achieved for identical sheets; i.e. sheets that all encode the same set of positions, by also recording the identities of the user units so that the system can connect the information from different user units with different database forms. Alternatively, data from identical sheets can be differentiated if the user, in connection with filling-in the form, operates the user unit to mark a personal identifying pattern. The personal identifying pattern may be unique to the respective user, and may for example be implemented as a pattern encoding a dedicated set of positions, or a bar code encoding a dedicated identifier.

Parallel recording can also be achieved for identical sheets by each such sheet being provided with an identifying pattern which not only identifies the form layout but also the printed form. Thus each printed sample of the form (form instance) may be given a unique identifier with is provided on the form as an identifying pattern.

In the exemplary identifying pattern of FIG. 2, boxes 209-212 may be marked with crosses. Alternative identifying patterns may involve dots to be circled. An advantage of marking boxes 209-212 with a cross is that the width and intensity of the four lines which make up the box can be made such that the position recording temporarily ceases when the optical sensor crosses the lines of the box because the lines prevent the optical sensor from detecting the position-coding pattern (or the position-coding pattern does not exist there). This means that the system can determine more precisely where in the position-coding pattern the box is located.

This principle may also be used in the embodiment of the identifying pattern 300 shown in FIG. 3. Here the pattern 300 consists of a set of parallel lines or bars 301, 302, etc., of different widths arranged beside each other (e.g., as a bar code). If the bar code is printed on a position-coding pattern and marked by having a line drawn through it essentially at right angles to the lines 301, 302, etc. using the user unit with an optical sensor, the position recording may be commenced and terminated several times as a result of interference of the bar code lines with the detection of the position-coding pattern by the optical sensor. Thus, the relative locations and widths of the bar code lines may be inferred from the absolute positions that are recorded by the user unit. Knowing the spacing and width of the vertical lines, the bar code can be decoded and used to identify the form layout. In one embodiment, the user unit may be caused to detect the bar code based upon the recorded absolute positions, i.e. user unit expects a bar code at a given location in the position-coding pattern.

The skilled person will realize that the translation from absolute positions to line spacing and line width may need to take into account any misfit between the loss of position data and the actual edges of the bar code lines, e.g. caused by the fact each position-coding symbol or group symbols has a certain spatial extent and/or by the effects of error correction schemes embedded in the position-coding pattern.

In an alternative embodiment, the bar code is identified and decoded in the user unit based upon its physical features in the recorded images. The image(s) may be recorded by the camera system (124 in FIG. 1C) used for detection of the position-coding pattern, or by an auxiliary camera system in the user unit. The image(s) may be recorded while the user unit is held stationary over the bar code, or, in particular if the bar code is larger than the field of view of the camera system, while the user unit is swept over the bar code.

In yet another embodiment, the identifying pattern comprises an identifier which is written, visibly to the user unit, in plain language on the form. Thus, the user unit may be brought to record images of this identifier and to operate optical character recognition (OCR) algorithms thereon, to derive the identifier. Such algorithms are well-known in the art. Instead of bringing the user unit to scan in the identifier, the form may prompt the user to write down, with the user unit, the identifier in one or more dedicated position-coded input fields, or to represent the identifier by marking, with the user unit, a combination of available position-coded selection fields. Each such selection field may represent a symbol, such as a character, a number, a color, etc.

A form in accordance with the present invention may be put to numerous uses, including market surveys, tests, medical records, and income-tax returns. This list is not intended to be exhaustive, and the invention is contemplated for use in connection with any form in which information is to be recorded and/or conveyed.

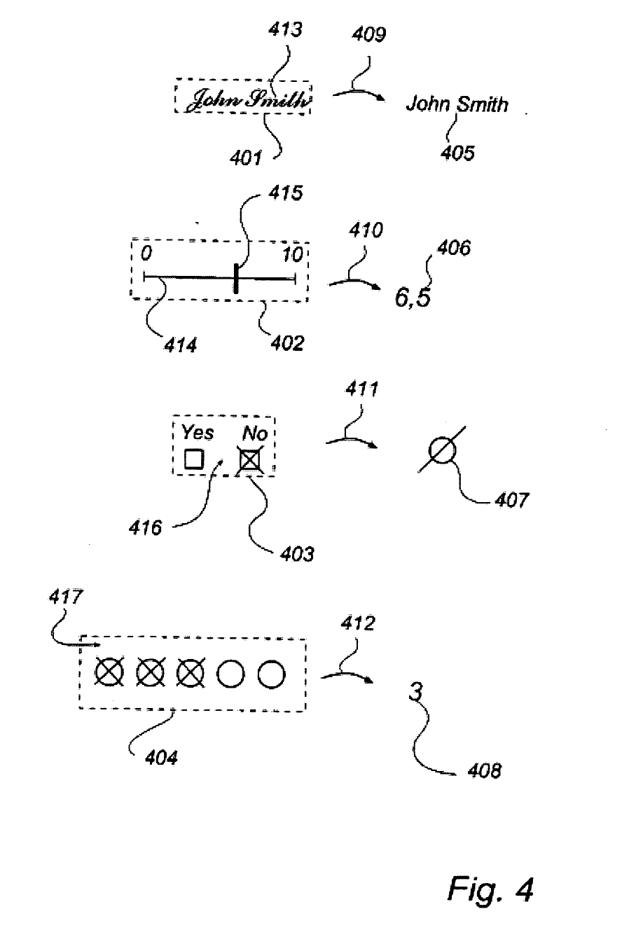

FIG. 4 shows the application of a number of processing rules or functions with position information as input data. On the left side of FIG. 4 is shown a number of entry fields 401-404, which may be completed by a user. On the right side of the figure is shown the information 405-408 which may be inserted in the corresponding information entries in a database when field-specific rules 409-412 of various kinds are applied to transform the items of position information (information entries) generated when the form is completed. Output data from such rules are generally obtained by processing the rule's input data.

In FIG. 4, a user has entered a name 413 in a first entry field 401. On the position information which then arose, a rule 409 is applied, which corresponds to Optical Character Recognition (OCR) of text on a sheet of paper. Output data 405 from this rule is thus a text string that can be stored or processed in the computer system. It is also possible to store the position information in an unprocessed state. One might want to do this to make a signature reproducible.

In a second entry field 402, the form layout consists of a scale 414 from 1 to 10 where a user may describe, for example, how satisfied he was with a particular product. The user has here put a line 415 slightly to the right of the center. When a rule 411 is applied to the position information which arose when the user marked the line 415, the output data 406 is a real number 6.5, which can be stored in a record of a database form.

In a third entry field 403, a user answers “yes” or “no” to a question. The form layout 416 consists of the words “yes” and “no” with associated boxes to be marked with crosses. The user has put a cross in the box signifying “no”. When a rule is applied to the position information which arose, the output data 407 may be a logical or Boolean zero.

In a fourth entry field 404, a user indicates how many items of a particular product he wants to order by marking a corresponding number of circles in box 417. The user has marked a cross in three circles. When a rule 412 is applied to the position information which arose, the output data 408 is the integer number 3.

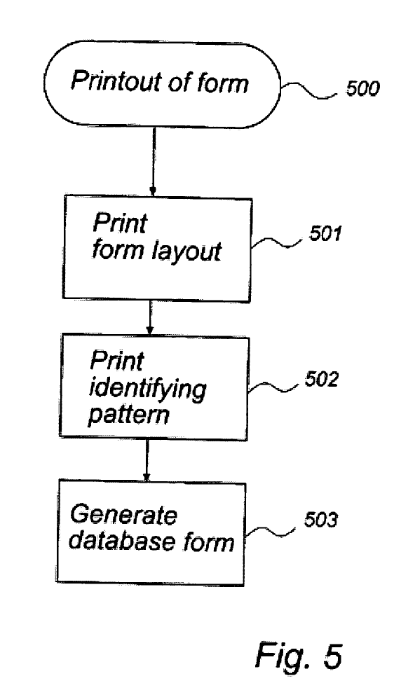

FIG. 5 shows a flow chart that describes a method 500 for generating forms in accordance with an exemplary embodiment of the present invention. A computer program may direct a printer to perform this method. In step 501, the form layout is printed. The actual form layout may be supplemented by graphics and text that are not necessarily strictly related to the form functionality. In step 502, an identifying pattern (identity pattern) may be printed. This identity pattern may identify the form layout, and optionally the form instance. In step 503, a database form is created in an associated computer system. The database form may be a virtual copy of the real form now created. For example, the database form may comprise records for data related to the real form and data related to information to be recorded by the user unit. Printing of the layout, printing of the identifying pattern, and printing of the position-coding pattern may all be printed simultaneously, but they could also be printed sequentially in any order.

The position-coding pattern may be arranged on the paper in advance, perhaps by an offset printer which may have a resolution above 1000 dpi. The form layout may then be printed on top of the position-coding pattern. Also, the printer may be provided with a position-coding pattern reader device in order to facilitate the printing of a form layout that is adapted to the position-coding pattern.

Alternatively, the position-coding pattern may be applied to the paper by a separate printer after printing the form layout, or with the same printer in a second run. It is also possible to use a copying machine for providing the paper with the form layout and/or the position-coding pattern.

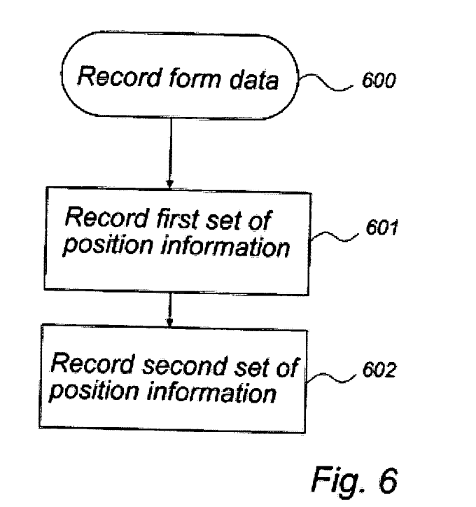

FIG. 6 shows a flow chart that describes a method 600 for recording and processing form data for an information entry in accordance with an exemplary embodiment of the present invention. A computer program may perform these steps. In step 601, a first set of position information, entered into an entry field, may be recorded. In step 602, a second set of position information, arising from marking of an identifying pattern with the user unit, may be recorded.

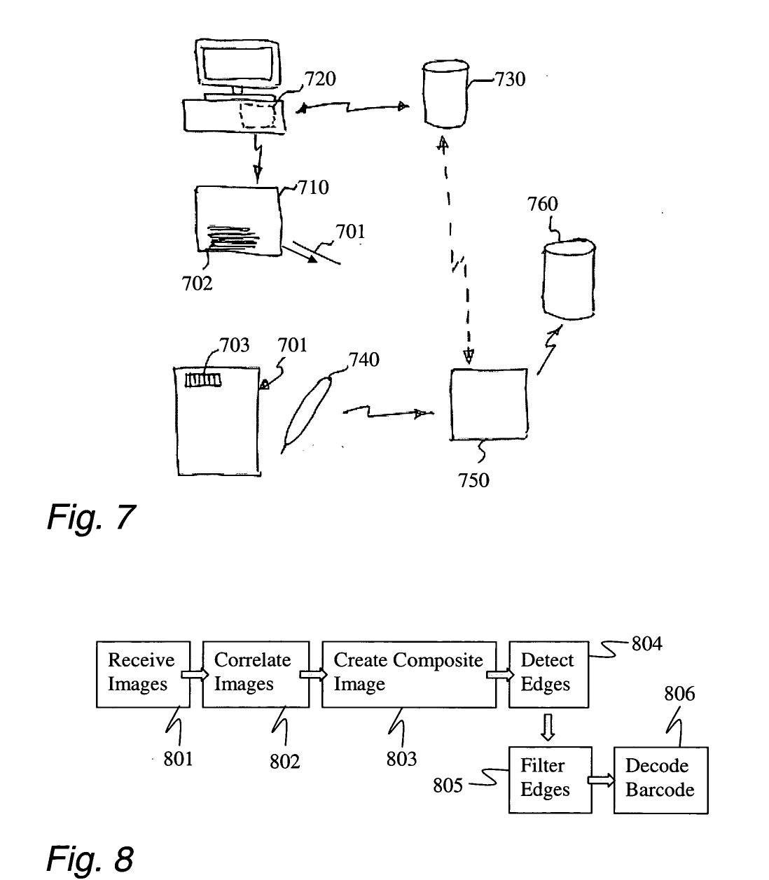

FIG. 7 illustrates an information management system in accordance with an exemplary embodiment of the present invention. In the system, encoded forms 701 are generated from pre-encoded sheets 702, i.e. sheets which are provided with a position-coding pattern but with no form layout. Such sheets 702 can be manufactured at low cost in high volumes, e.g. by conventional offset printing, and be made available to different system providers or service providers. For reasons of logistics and stock-keeping, the number of sheets encoding different sets of positions may be limited. Therefore, to differentiate different form layouts or form instances which are generated from identical pre-encoded sheets, a bar code 703 is applied to the pre-encoded sheets 702.

To this end, the system of FIG. 7 comprises a printer 710 for applying a form layout and an identifying bar code 703 to a pre-encoded sheet 702, so as to output (illustrated by arrow) an encoded form 701. The printer may be controlled to print the bar code 703 on top of a position-coded part of the sheet 702. If the bar code 703 is printed to obscure the position-coding pattern, the bar code could be identified based upon the decoded positions. If the bar code 703 is visible to user units in the system, the bar code could be identified based on its features in the recorded images. Alternatively, the printer 710 may be controlled to print the bar code 703 in a non-encoded part of the sheet 702, and the bar code be identified based upon its physical appearance in the images. In yet another alternative, the system may include a label printer (not shown) which may be controlled to print the bar code 703 on an adhesive label to be attached to the pre-encoded sheet 702, either before or after the printing of the form layout on the sheet by means of the printer 710. Depending on method for identifying the bar code 703, the label material may be transparent to the user units or not.

The system also comprises a control module 720 which controls the generation of a form, based upon a form layout, and operates in relation to a first database 730. The control module 720 may be implemented by software executed on a computer. The system further comprises a user unit 740 which digitizes its handwriting motion on the form into sequence(s) of absolute positions, given by the position-coding pattern on the form. The user unit 740 is also capable of recording data indicative of the bar code 703 on the form. The system further comprises a forms data processor 750, which receives input data from the user unit 740, processes this input data to generate output data for storage in a second database 760. It should be realized that the first and second databases 730, 760 may be part of one and the same overall database. The input data may be in any format, e.g. raw images recorded by the optical sensor of the user unit, positions decoded by the control device of the user unit, the identifier encoded by the bar code, data derived by recognition processing of handwriting, wholly or partly based on knowledge of the form layout, etc. The forms data processor 750 may be implemented by software executed on a computer.

In a first variant, the bar code 703 represents an identifier of the form layout (“form identifier”). In this case, the control module 720 may allow a user, via a suitable graphical user interface (GUI), to select a form layout from the first database 730. The control module 720 may derive the form layout and its form identifier from the first database 730. The control module 720 may also be operated to connect to further databases to derive data unique to each printout or a set of printouts, e.g. a name and other particulars to be printed together with the form layout. Then, the control module 720 transfers printing instructions to the printer 710 for printing of the form layout, the bar code and any data unique to each printout. The control module 720 may also derive information on the positions encoded on the pre-encoded sheets 702 in the printer 710, either by prompting the user to input this information, or by receiving this information from a position sensor in the printer 710. This position information may then be stored in the first database 730 in association with the form layout/form identifier.

Upon receipt of input data from the user unit 740, the forms data processor 750 extracts the bar-coded form identifier, and derives, based upon the form identifier, a set of processing rules for the corresponding form layout. As discussed above, these processing rules may be dedicated to operate on data from certain entry fields on the form, the data being identified from the positions which are known to be encoded within the respective entry field. The forms data processor 750 may need to consult the first database 730 to derive data on the positions encoded on the form, and thus the positions within each entry field on the form. The forms data processor 750 also derives the handwriting data from the input data and operates the respective processing rules thereon. In an alternative, the forms data processor 750 derives the form layout from the first database 730 based upon the form identifier and then displays the handwriting data superimposed on the form layout, to enable manual interpretation by a user who then generates at least part of the output data. In either case, the resulting output data is stored in a corresponding database form in the second database 760. The database form may comprise records which correspond to the different entry fields in the form layout. If available, the forms data processor 750 may also derive the above-mentioned user unit identifier or the above-mentioned personal identifier as given by a personal identifying pattern recorded by the optical sensor in the user unit, for storage in association with the corresponding output data in the database form.

In a second variant, the bar code 703 represents an identifier of a specific form printout (“form instance identifier”). This form instance identifier may be indicative of both the form layout and of a particular form instance in the system. Again, the control module 720 may allow a user, via a suitable graphical user interface (GUI), to select and derive a form layout from the first database 730. The control module 720 then generates a unique form instance identifier for each printout to be made. This form instance identifier may include a first part which is indicative of the form layout and second part which is indicative of the printout. The control module 720 may also be operated to connect to further databases to derive data unique to each printout or a set of printouts, e.g. a name and other particulars to be printed together with the form layout and/or to be stored in association with the form instance identifier in the first database 730. Alternatively, a link to such other particulars may be stored in the database 730. Similar to the first variant, the control module 720 may also derive information on the positions encoded on the pre-encoded sheets 702 in the printer 710, and store this position information in the first database 730 in association with the form layout/form identifier or the form instance identifier. The printing of the form is executed as in the first variant.

Upon receipt of input data from the user unit 740, the forms data processor 750 extracts the bar-coded form instance identifier, and derives, based upon the form instance identifier, a set of processing rules for the corresponding form layout. As in the first variant, the forms data processor 750 may need to consult the first database 730 to derive data on the positions encoded on the form, and thus the positions within each entry field on the form. As in the first variant, the forms data processor 750 derives the handwriting data from the input data and operates the respective processing rules thereon to generate output data which is associated with the form instance identifier. For each form instance identifier, a new database form may be generated in the second database 760. If a database form already exists for a particular form instance identifier, the output data may be added to the existing database form. As in the first variant, the database form may comprise records which correspond to the different entry fields in the form layout. If available, the forms data processor may also derive the above-mentioned user unit identifier or the above-mentioned personal identifier as given by a personal identifying pattern recorded by the optical sensor in the user unit, for storage in association with the corresponding output data in the database form.

In the second variant, it should be noted that the form instance identifier need not be indicative of the form layout. Instead, the form layout may be given by the positions encoded on the printed form. Thus, the control module 720 may generate a unique form instance identifier for each printout to be made of a particular form layout, and initiate the printer to generate printouts with correspondingly unique bar codes. The same set of positions may be encoded on all instances of the form layout. The association between form layout/form identifier and encoded positions may be created and/or recorded by the control module 720 and stored in the first database 730. For example, the control module 720 may initiate the printer 710 to apply both position-coding pattern, form layout and bar codes to blank sheets, or to apply form layout and bar codes to pre-encoded sheets, or to apply bar codes to pre-encoded forms, i.e. sheets which are provided with both position-coding pattern and form layout. In either case, the control module 720 may also derive data unique to each printout or a set of printouts, e.g. a name and other particulars for printing and/or storage in association with the form instance identifier in the first database 730. Upon receipt of input data from the user unit 740, the forms data processor 750 may derive, based upon one or more positions included in the input data, a set of processing rules for the corresponding form layout. The forms data processor 750 may then operate the respective processing rules on the handwriting data to generate output data. The forms data processor 750 may also extract the bar-coded form instance identifier from the input data and store the output data in the second database 760 in association with the form instance identifier.

In should also be clear to the skilled person that the above first and second variants may be combined to provide a system that allows generation of certain forms with bar codes representing form identifiers, and other forms with bar codes representing form instance identifiers.

It should be noted that there are other potential uses for bar code reading capability in a user unit for reading off a position-coding pattern. Such a user unit may support registration of a product which is labelled with a bar code and a possibility to link the bar code, and thereby the product or information related thereto, to a position-coded form. There is an almost endless number of conceivable application examples, all capitalizing on the notorious availability of bar codes for identification of products, persons, tasks, instructions etc. In one such application example, the user unit is operated to fill in a form for stock-taking, in which the number of items in stock of specific products may be noted in dedicated position-coded fields, while the identity of the respective product is inputted by the user unit reading off a bar code from a separate bar code list or from an actual product in stock. In another implementation example, the user unit reads off a bar code that identifies a specific patient which is to be associated with position data recorded on a position-coded medical chart. In yet another application example, one of more bar codes are read off from a medical drug inventory catalogue to identify a particular drug to be associated with a position-coded prescription form.

In the following, an approach for identifying and decoding a bar code based upon its physical features in the recorded images will be described with reference to FIGS. 8-14. This approach is based on three main steps: 1) acquire image(s) of the bar code; 2) identify all edges defined by the bars of the bar code; and 3) decode the bar code using the thus-identified edges.

There are several conceivable algorithms to be used in basic step 2. In one such algorithm, full resolution images, or at least image strips extending essentially along the bar code, are processed to locally detect edges in each image. These edges are then classified by their location in the image and by a probability value. The probability value may represent the image intensity at the edge. The edges may then be stitched together using error correction and dynamic programming, e.g. Viterbi algorithms, to get a complete sequence of edges representing the full bar code.

Likewise, there are several conceivable algorithms to be used in basic step 3. In one such algorithm, the white and black sections are separated based upon the sequence of edges given by step 2, whereupon a Fourier transform is operated thereon to determine the module size of the bar code. The module (also called “basic element”) denotes the smallest width of bars or spaces in a bar code. This approach to step 3 has proved to be essentially unaffected by any gain in the module size due to printing artifacts and sensor exposure effects. Then, the size of each of the bars is classified to a certain number of modules. After such module classification, decoding is straightforward, as readily understood by the skilled person.

Although being quite operable, these algorithms for basic steps 2 and 3 can be further improved with respect to stability and robustness, as will be described in the following. The algorithms for identifying and decoding of bar codes as described herein may be executed by the control device in the user unit. Alternatively, all or parts of these algorithms may be executed by a corresponding control device in an external apparatus which receives recorded data from the user unit.

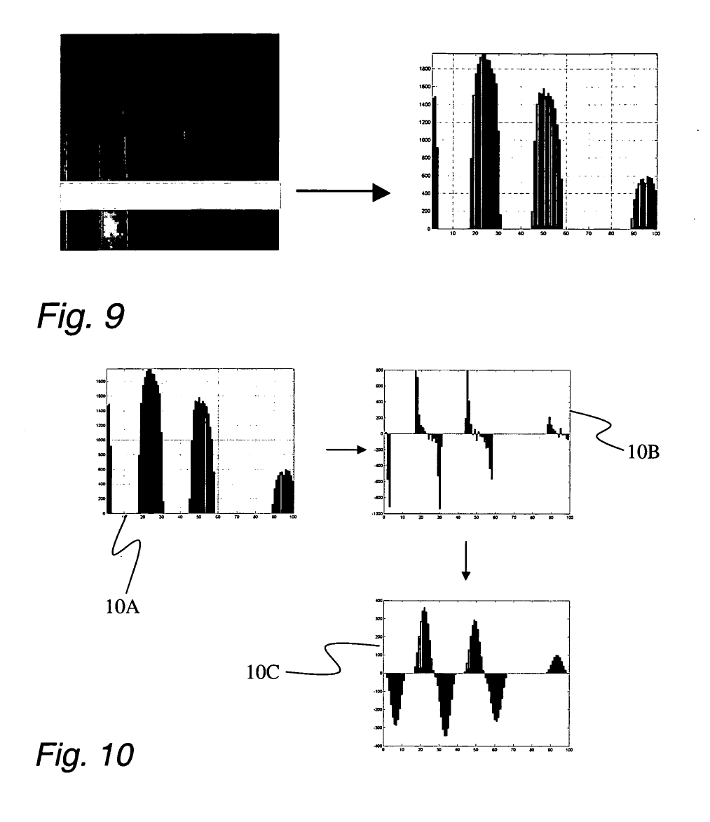

FIG. 8 is a schematic view of an image processing procedure implemented by the control device according to an exemplary embodiment of the invention. A first part of the image processing procedure (step 801) comprises receiving images, typically grayscale images, recorded by an optical sensor in the user unit. In order to reduce the demands on processing power and memory, as well as to reduce the impact of noise, a rectangular subset of the image (“image strip”), extending across the bars in the image, may be used in the further processing instead of the full image. This image strip, which is indicated as an opaque band in the left-hand image of FIG. 9, is made up of a two-dimensional matrix of image pixels, each holding a luminance value. The image strip may then be “binned” in its transverse direction, by summing or averaging the luminance values at each longitudinal pixel position in the image strip, to create a one dimensional (1D) image profile, as shown to the right in FIG. 9.

In a subsequent step 802, 1 D image profiles are pair-wise correlated to detect the incremental displacement between two images. Before the actual correlation step, a number of sub-steps may be effected. A first sub-step may be to differentiate each original profile (10A in FIG. 10) resulting from step 801, where d(n)=x(n+1)−x(n), resulting in a differentiated profile (10B in FIG. 10). Then, the differentiated profile may be low-pass filtered, for example with an 8-order FIR filter kernel, for example given by [0.047, 0.101, 0.151, 0.187, 0.200, 0.187, 0.151, 0.101, 0.047], to reduce any high-frequency elements. In one embodiment, the resulting low-pass filtered profiles (10C in FIG. 10) are used for correlation, whereas the original 1D image profiles are used for composing the complete bar code profile, as will be described below. Using low-pass filtered profiles in the correlation may be important, not only to reduce the influence of noise, but also to increase the robustness of the correlation process. Variations in the spatial orientation of the user unit while it is swiped across the bar code may lead to a change in spacing of a given set of edges from one image to the next, e.g. due to variations in perspective. If this change in spacing exceeds the width of the edges in the differentiated profile (see peaks in 10B in FIG. 10), the correlation process may result in an insignificant correlation value, ultimately resulting in a failure to identify the bar code. Since the low-pass filtering results in a broadening of the edges in the differentiated profile (see peaks in 10C in FIG. 10), the tolerance of the correlation process to changes in edge spacing between images is enhanced correspondingly.

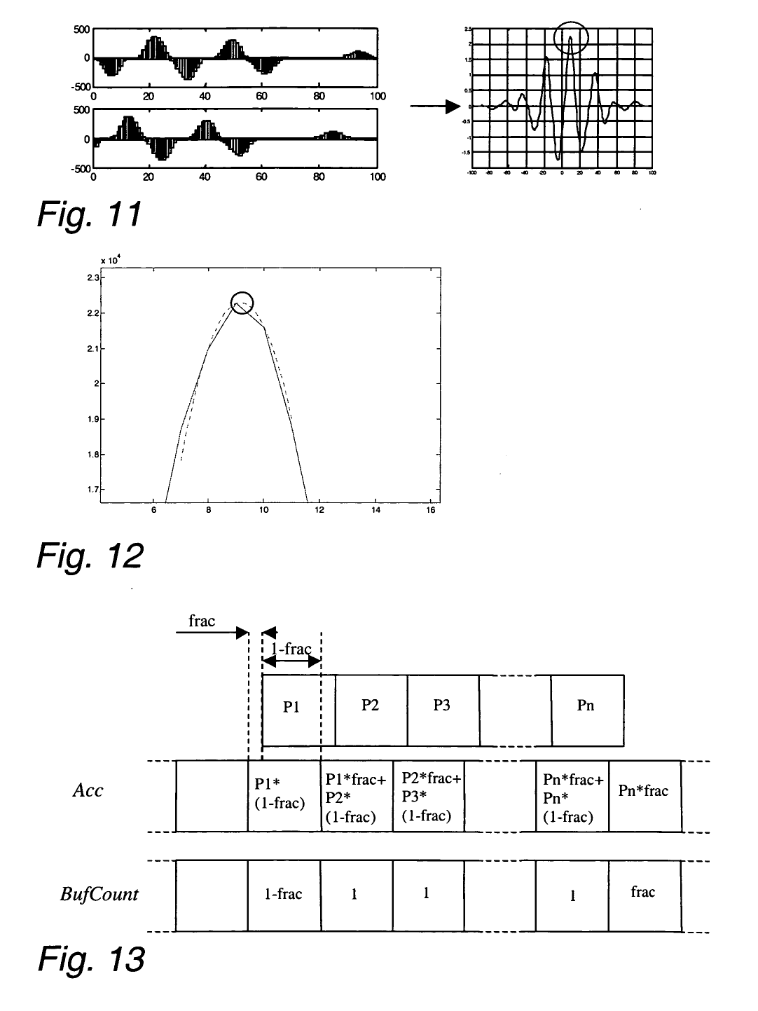

In the actual correlation step, two consecutive differentiated, low-pass filtered profiles are correlated, as shown to the left in FIG. 11. The result of the correlation, as shown to the right in FIG. 11, may be normalized with respect to correlation overlap, and operated with (multiplied by) a window weighting function to suppress results that are considered unlikely. Many possible window weighting functions are known to the skilled person, e.g. Hamming, Hanning, Triangle, Blackman, etc. For the first correlation, the window may initially be set to expect correlation results centered around zero, i.e. not to favor scanning right-to-left to scanning left-to-right. In subsequent pair-wise correlations, the last known correlation shift may be set as center of the window weighting function. This would give the system certain inertia, where extremely high changes in speed (corresponding to unnatural acceleration), between images, are suppressed. The peak in the result of the correlation may be fit to a second-order polynomial to extract sub-pixel accuracy in the displacement. FIG. 12 shows such a fit, with a circle indicating the peak of the sub-pixel displacement. This sub-pixel or fractional part may be calculated as:

$$frac = \frac{{y}_{i - 1} - {y}_{i + 1}}{2 ( {y}_{i - 1} + {y}_{i + 1} - 2 {y}_{i} )}$$

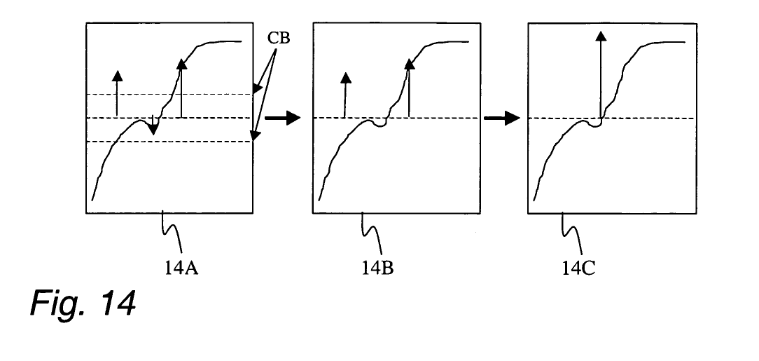

Thus, the correlation step 802 results in a series of 1D image profiles and the relative displacements between them. In a subsequent step 803, the original (i.e. non-filtered) 1D image profiles are merged to form a single bar code profile. First, the length of the final resultant profile may be calculated by identifying the longest coherent sequence of displacements that results from the correlation process, and cumulatively summing up these displacements. Then, two buffers are allocated, as illustrated in FIG. 13, one (Acc) holding an accumulator element for each pixel over the length of the final resultant profile and the other (BufCount) holding the number of image profiles contributing to each accumulator element in the accumulator. Then, for each image profile, the contributions from its pixels P₁-Pₙ are input to the respective elements of the accumulator. Since fractional displacements are used, the contributions will also be fractional. In FIG. 14, the contents of the two buffers (Acc, BufCount) are illustrated after processing of a first image profile. When all 1D image profiles have been processed, the resultant pixel values are calculated as: Pₙ=Accₙ/BufCountₙ.

In an ensuing step 804, the bar code profile resulting from step 803 is differentiated and the result is processed to yield an edge position-weight representation. The following sub-steps may be used: (sub-step 804A) calculate a differentiated bar code profile, dₙ=pₙ₊₁−pₙ; and (sub-step 804B) for each continuous sequence m of differentiated values dₙ with the same sign, calculate the weight wₘ and center of gravity cgₘ as:

$${w}_{m} = {\sum }_{x} {d}_{x} ; {cg}_{m} = \frac{{\sum }_{x} \vert x {ⅆ}_{x} \vert}{{\sum }_{x} \vert {ⅆ}_{x} \vert} ,$$

respectively.

The resulting edge list (wₘ,cgₘ) will have alternating signs on wₘ, and is sorted so that cgₘ is strictly increasing.

Each consecutive pair of edges in the edge list will correspond to a band or bar in the bar code, wherein a positive wₘ followed by a negative wₘ₊₁ represents a band brighter than the surroundings, and a negative wₘ followed by a positive wₘ₊₁ represents a dark bar.

Using the original (non-filtered) 1D image profiles (instead of the low-pass filtered differentiated profiles used in the correlation process) for composing the complete bar code profile ensures that all data available is used, which may be important for proper detection of all edges. However, the complete bar code profile may then also contain components of noise. High-frequency noise may generate “false” bars and bands in the edge list representation of the bar code. Low-frequency noise, which may appear in the images due to non-uniformities in the illumination of the bar code, perspective distortion in the images or non-uniformities in the printing of the bar code, will modulate the overall brightness. A step 805 may be designed to reduce any artifacts resulting from such noise. The step 805 may include eliminating from the edge list all weights wₘ that are less than a predetermined overall threshold value. Such an overall threshold value may be difficult to determine, since it will depend on the quality of the bar code print, the illumination, the sheet material, etc. Instead, the weights in the edge list may be examined based upon a set of rules for their mutual relations. One exemplary embodiment is based upon the following sequence of sub-steps: (sub-step 805A) find adjacent pairs of edges (i.e. bars or bands) that fulfill the relationship |wᵢ|+|wᵢ₊₁|<cₛₘₐₗₗₚₐᵢᵣ(cₛₘₐₗₗₚₐᵢᵣ is a constant which may be determined experimentally) and delete them from the edge list, to thereby eliminate small high-frequency noise bands; (sub-step 805B) find and delete individual edges where |wᵢ|<c_{cutoff}(c_{cutoff} is a constant which may be determined experimentally, c_{cutoff}<cₛₘₐₗₗₚₐᵢᵣ/2), to thereby remove small edges resulting, i.a., from non-uniform illumination and noise; the first and last edges require special treatment (sub-step 805C), so they are checked against c_{border}_{_{−}}_{cutoff} (denoted by CB in FIG. 14) and may be deleted accordingly; and (sub-step 805D) merge adjacent edges with the same sign, in the edge list resulting from sub-steps 805A-805C, by calculating a new weight and a new center of gravity as:

$${w}_{i} = {w}_{i} + {w}_{i + 1} ; {cg}_{i} = \frac{{cg}_{i} \vert {w}_{i} \vert + {cg}_{i + 1} \vert {w}_{i + 1} \vert}{\vert {w}_{i} + {w}_{i + 1} \vert} .$$

FIG. 14 illustrates an exemplary subset of a 1D image profile during different stages of processing (14A-14C). To visualize the effects of the processing, edges included in a current edge list are superimposed on the image profile. In going from 14A to 14B, sub-step 805B eliminates a small fictitious negative edge, and in going from 14B to 14C, sub-step 805D merges the remaining adjacent edges to form a new edge.

When a correct bar code edge list has been established, the resulting bar code can be decoded using standard reference algorithms (step 806), for example as published by EAN International, Uniform Code Council Inc (UCC) and AIM Inc. The above-described algorithm has been successfully tested for identifying and decoding of bar codes belonging to the following symbologies: EAN 8, EAN 13, Code 2/5 Interleaved, Codabar, and Code 39, but the above-described algorithms are not limited to these symbologies.

Following step 806, it may be desirable for the control device to issue a confirmation signal to the user to indicate whether the bar code has been properly decoded or not. Such a confirmation signal may be issued by activation of the user unit's MMI (136 in FIG. 1C).

An alternative technique for identifying and decoding a bar code is disclosed in international patent publication WO 01/93183, the technical disclosure of which is hereby incorporated herein by reference. It is conceivable to supplement or replace one or more of the steps of the method described above with respect to FIGS. 8-14 with one or more of the steps disclosed in WO 01/93183. For example, a technique for locating a direction perpendicular to the bars in any image, as described in WO 01/93183, could be used to ascertain that the image strip (cf. FIG. 9) extends essentially perpendicularly to the bars in each image.

Irrespective of the technique used to read off the bar code, it may be desirable to indicate to the user unit's control device that a bar code is to be recorded. Such an indication may set the user unit in a bar code reading mode, in which the control device executes dedicated algorithms for detection and, optionally, decoding of bar codes based upon recorded images. The indication may result from a button on the user unit being pushed, or a voice command being recorded by a microphone on the user unit.

In another embodiment, the indication results from the control device detecting a dedicated pattern in an image recorded by the camera system. For example, such a dedicated pattern may be a subset of the position-coding pattern that represents one or more dedicated positions. Since the user unit normally is operated to convert recorded images into positions, it will be capable of recording, during normal operation, a position which causes its control device to switch to the bar code reading mode. In one implementation, the user unit may be configured to enter and stay in the bar code reading mode until the end of the current pen stroke, i.e. until the user unit is lifted (pen up). The bar code scan begins by the user unit being put down on the dedicated pattern and then being drawn across the bar code in contact with the supporting base, from left to right or right to left. In another implementation, the user unit may be configured to enter and stay in the bar code reading mode until the end of the next pen stroke. This implementation allows the dedicated pattern to be separate from the bar code. In yet another implementation, the user unit may be configured to enter and stay on the bar code reading mode for a predetermined period of time.

The maximum swipe speed of the user unit when reading a bar code is directly proportional to the frame rate of the camera system. In the above method, consecutive images should preferably overlap by at least ¼, and most preferably by at least ½, in order for the correlation and merging steps (cf. steps 802-803 in FIG. 8) to yield sufficiently stable results. In one particular embodiment, a frame rate of 100 Hz was found to support maximum swipe speeds of about 0.15 m/s. If higher swipe speeds are desired, for example 0.5 m/s or 0.75 m/s, correspondingly higher frame rates may be required. However, power consumption raises with frame rate, and a high power consumption may be unwanted in a handheld device. The position decoding process, on the other hand, need not be dependent on frame rate, if the position-coding pattern supports determination of a position based upon the data within each individual image. Therefore, the frame rate for position determination may be set at 70-100 Hz, which is known to yield acceptable spatial resolution of digitised pen strokes at normal handwriting speeds. To allow for high bar code swiping speeds, while still keeping power consumption down, the control device of the user unit may be configured to selectively increase the frame rate of the camera system in the bar code reading mode only, for example to a frame rate of 100-500 Hz.

In a further embodiment, the control device of the user unit is configured to indicate to the user, by activating the user unit's MMI, whenever the swipe speed is unsuitably high. Thereby, the user can be controlled not to use excessive swipe speeds. The swipe speed could, for example, be represented to the control device by the relative displacement resulting from the correlation step (cf. step 802 in FIG. 8).

While recording of a form created in accordance with the foregoing methods does not necessarily require a flat-bed scanner equipped with advanced software for image analysis, the invention in its broadest sense may be used in conjunction with many types of technology without departing from the scope or spirit of the invention.

The scope of protection applied for is not restricted to the embodiments described above. The invention can be varied within the scope of the appended claims.

The following U.S. patent applications were filed concurrently with the patent application on which this continuation-in part is based: Ser. Nos. 09/812,885; 09/813,115; 09/812,905; 09/812,901; 09/812,902; 09/812,900, issued as U.S. Pat. No. 6,689,966; Ser. Nos. 09/812,892; 09/813,117; 09/812,882; 09/813,116; 09/812,898; 09/813,114; 09/813,113, issued as U.S. Pat. No. 6,586,688; Ser. Nos. 09/813,112; 09/812,899; 09/812,907; and U.S. Provisional Application No. 60/277,285 entitled “Communications Services Methods and Systems”.

The technical disclosures of each of the above-listed U.S. applications are hereby incorporated herein by reference. As used herein, the incorporation of a “technical disclosure” excludes incorporation of information characterizing the related art, or characterizing advantages or objects of this invention over the related art.

In the foregoing Description of Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Embodiments, with each claim standing on its own as a separate embodiment of the invention.

What is claimed is:

1. A form, comprising:
a surface;
a position-coding pattern located on the surface and optically detectable by a pen device;
a form layout on the surface indicating at least one position-coded entry field for receipt of information; and
a bar code located on the surface and optically detectable by the pen device, the bar code being indicative of at least one of the form layout and a unique identity of the form.

2. The form of claim 1, wherein the bar code is located spatially separate from the position-coding pattern.

3. The form of claim 1, wherein the bar code is superimposed on the position-coding pattern.

4. The form of claim 3, wherein the bar code prevents the pen device from detecting the position-coding pattern on portions of the surface covered by bars of the bar code but allows the pen device to detect the position-coding pattern between the bars of the bar code, the bar code being detectable based upon positions encoded by the position-coding pattern between the bars.

5. The form of claim 1, wherein the bar code is printed on a label which is attached to the surface.

6. The form of claim 5, wherein the label is made of a material which is optically transparent to the pen device.

7. The form of claim 1, wherein the entry field comprises space for receiving handwritten information.

8. The form of claim 1, wherein the position-coding pattern encodes at least one absolute position.

9. The form of claim 1, wherein the position-coding pattern comprises symbols associated with grid points of a grid, said position-coding pattern encoding a plurality of positions on the surface, each position being encoded by a plurality of said symbols, wherein each symbol contributes to the encoding of more than one of the plurality of positions.

10. The form of claim 1, wherein the position-coding pattern comprises symbols associated with grid points of a grid, a value of each symbol being determined by a displacement of a marking in relation to said grid point.

11. A method for generating a form, comprising:
on a surface having a position-coding pattern detectable by an optical detector, printing a form layout indicating at least one position-coded entry field for receipt of information; and
printing on the surface a bar code indicative of the form layout.

12. The method of claim 11, wherein printing on the surface the form layout comprises printing the form layout at a known location relative to the position-coding pattern.

13. The method of claim 11, further comprising: selecting the form layout from a plurality of form layouts; deriving surface data indicative of positions encoded by the position-coding pattern on the surface; and storing the surface data in association with a form identifier indicative of the form layout, said bar code representing the form identifier.

14. The method of claim 11, further comprising: deriving a unique form instance identifier for each individual printing of a form layout, said bar code representing the form instance identifier.

15. The method of claim 14, further comprising: deriving, for each individual printing of a form layout, instance data associated with said individual printing; and storing the instance data in association with the form instance identifier.

16. The method of claim 15, further comprising: printing at least part of the instance data together with the form layout on the surface.

17. System for generating a form, comprising:
a printer for holding a plurality of surfaces, each having a position-coding pattern detectable by an optical detector; and
a controller operatively connected to the printer to initiate printing, on one of the surfaces, a form layout indicating at least one position-coded entry field for receipt of information; and to initiate printing on the surface of a bar code indicative of the form layout.

18. The system of claim 17, wherein said controller is configured to derive surface data indicative of positions encoded by the position-coding pattern on the surface; and store the surface data in association with a form identifier indicative of the form layout, said bar code representing the form identifier.

19. The system of claim 17, wherein said controller is configured to derive a unique form instance identifier for each individual printing of a form layout, said bar code representing the form instance identifier.

20. The system of claim 19, wherein said controller is configured to derive, for each individual printing of a form layout, instance data associated with said individual printing; and store the instance data in association with the form instance identifier.

21. The system of claim 20, wherein said controller is configured to initiate printing of at least part of the instance data together with the form layout on the surface.

22. A method for generating a form, comprising:
printing on a surface a position-coding pattern detectable by an optical detector;
printing on the surface a form layout indicating at least one entry field for receipt of information; and
printing on the surface a bar code indicative of each individual printing of a form layout.

23. The method of claim 22, further comprising: deriving surface data indicative of positions encoded by the position-coding pattern on the surface; and storing the surface data in association with a form identifier indicative of the form layout.

24. The method of claim 22, further comprising: deriving, for each individual printing of a form layout, instance data associated with said individual printing; and storing the instance data in association with a form instance identifier, said bar code representing the form instance identifier.

25. The method of claim 24, further comprising: printing at least part of the instance data together with the form layout on the surface.

26. A method for processing a form, comprising:
receiving, from an optical position detector, position data corresponding to movement of a device containing the optical position detector over a surface having a position-coding pattern detectable by the optical position detector;
receiving, from a bar code detector in the device, bar code data representing a bar code on the surface;
determining from the bar code data a form layout printed on the surface; and
determining from the position data an information entry in an entry field defined by the form layout.

27. The method of claim 26, further comprising: storing the information entry in a database.

28. The method of claim 26, further comprising:
translating the information entry into a non-handwritten format based on a type of information expected to be received in the entry field; and
storing the translated information entry in a database.

29. The method of claim 26, further comprising:
determining from the bar code data an instance identifier which is indicative of an individual identity of the surface; and
storing the information entry in a database in association with the instance identifier.

30. A computer-readable medium having computer-executable instructions for performing the method of 26.

31. A method for processing a form, comprising:
receiving, from an optical position detector, position data corresponding to movement of a device containing the optical position detector over a surface having a position-coding pattern detectable by the optical position detector;
receiving, from a bar code detector in the device, bar code data representing a bar code on the surface;
determining from the position data a form layout printed on the surface; and
determining from the bar code data an instance identifier which is indicative of an individual identity of the surface.

32. The method of claim 31, further comprising: determining from the position data an information entry in an entry field defined by the form layout.

33. The method of claim 32, further comprising: storing the information entry in a database in association with the instance identifier.

34. A computer-readable medium having computer-executable instructions for performing the method of 31.

35. Method in a pen device, comprising:
capturing images of a surface using an optical detector in the pen device; and
selectively activating a position detection process or a bar code detection process to operate on at least a subset of said images, the position detection process resulting in position data and the bar code detection process resulting in bar code data.

36. The method of claim 35, wherein the bar code detection process is activated upon detection of a predetermined pattern in at least one of said images.

37. The method of claim 36, wherein said at least one image is part of a sequence of images taken during a period of proximity between the pen device and the surface, the bar code detection process being terminated upon termination of said proximity.

38. The method of claim 36, wherein said at least one image is part of a sequence of images taken during a period of proximity between the pen device and the surface, the bar code detection process being terminated upon completion of a sequence of images resulting from a subsequent period of proximity between the pen device and the surface.

39. The method of claim 36, wherein the bar code detection process is terminated a predetermined period of time after its activation.

40. The method of claim 35, wherein the position detection process operates the optical detector at a first image capture rate, and the bar code detection process operates the optical detector at a second image capture rate which exceeds the first image capture rate.

41. The method of claim 35, further comprising: associating said bar code data with position data resulting from a preceding and/or subsequent activation of the position detection process.

42. The method of claim 35, wherein the bar code data results from sequences of positions decoded from said subset of images.

43. The method of claim 35, wherein said bar code detection process comprises:
inputting a sequence of images of at least portions of the bar code during moving of the optical detector across the same;
identifying relative displacements between pairs of said images; and
reconstructing the bar code using the images and the relative displacements.

44. The method of claim 43, wherein said identifying comprises: determining, for each image, a one-dimensional luminance profile representing the portion of the bar code in the image; differentiating the resulting one-dimensional luminance profiles; low-pass filtering the resulting differentiated profiles; and correlating the resulting low-pass filtered profiles in pairs to identify said relative displacements.

45. The method of claim 43, wherein the identifying comprises: correlating one pair of images to determine a correlation-displacement function; operating on said correlation-displacement function with a window function; and determining the relative displacement from the resulting windowed correlation-displacement function.

46. The method of claim 45, wherein, following determination of the relative displacement for said one pair of images, the window function is centered around this relative displacement when operating on a correlation-displacement function determined for a subsequent pair of images.

47. The method of claim 45, wherein the window function, at least when operating on the correlation-displacement function determined for an initial pair of images, is centered on zero relative displacement.

48. The method of claim 43, wherein the reconstructing comprises: determining, for each image, a one-dimensional luminance profile representing the portion of the bar code in the image; and merging the one-dimensional luminance profiles using the relative displacements, to form a bar code profile.

49. The method of claim 48, wherein the bar code profile comprises a sequence of luminance elements, and wherein said merging comprises aligning the one-dimensional profiles with said luminance elements according to their relative displacements, and averaging, for each element, the values of the luminance profiles at the location of the element.

50. The method of claim 48, further comprising: differentiating the bar code profile; and deriving a sequence of edges by calculating the center of gravity of each continuous sequence of differentiated values with the same sign.

51. The method of claim 50, further comprising: deriving a sequence of edge intensities by calculating the weight of each continuous sequence of differentiated values with the same sign; and applying a set of rules to amend the sequence of edges based on the sequence of edge intensities.

52. The method of claim 51, wherein the set of rules comprises: eliminating adjacent edges with a combined absolute weight which is less than a predetermined threshold value.

53. The method of claim 51, wherein the set of rules comprises: replacing adjacent edges with the same sign in the sequence of edges by the center of gravity of the combined differentiated values for these adjacent edges.

54. The method of claim 50, further comprising: decoding the bar code based upon the sequence of edges.

55. A computer-readable medium having computer-executable instructions for performing the method of 35.
